(19) United States
(12) Patent Application Publication
(10) Pub. No.: US 2015/0089774 A1
(43) Pub. Date: Apr. 2, 2015

(54) Cable Management Device

(71) Applicant: Charles Kalejaiye, Calumet City, IL (US)

(72) Inventor: Charles Kalejaiye, Calumet City, IL (US)

(21) Appl. No.: 14/504,421

(22) Filed: Oct. 2, 2014

Related U.S. Application Data
(60) Provisional application No. 61/885,913, filed on Oct. 2, 2013.

(51) Int. Cl. H02G 3/04

(52) U.S. Cl. CPC H02G 3/0437
USPC 24/122.3

(57) ABSTRACT

Disclosed is a cable management device. The purpose of the present invention is to organize cords in an orderly manner, while providing convenient access to individual cables and preventing cables from entanglement. The device includes a plurality of housing members that are box-like in shape. In one embodiment, the housing members are color coded. The housing members each include a channel for receiving an electrical cord therein. Each channel extends through the length of the housing member so as to allow an electrical cord to be threaded therethrough. The cords are secured in the channel by way of a lid that is pivotally attached to the top of the housing member. The housing members are removably connected to each other via a connecting member that comprises a connecting member, thereby allowing a user to utilize as many housing members as necessary.

### CROSS REFERENCE TO RELATED APPLICATION

This application claims the benefit of U.S. Provisional Application No. 61/885,913 filed on Oct. 2, 2013. The above identified patent application is herein incorporated by reference in its entirety to provide continuity of disclosure.

### BACKGROUND OF THE INVENTION

1. Field of the Invention

The present invention relates to a cable management device. More specifically, the present invention pertains to an improved cable management device comprising a plurality of color coded housing members having a channel for receiving an electrical cord therein. The present invention organizes electrical cords and reduces tripping and fire hazards, and is suitable for use in homes, offices, retail spaces, and other similar venues.

Proper cable management is necessary for a safe living and working environment. Cords that are piled up on the floor or hung behind equipment are likely to suffer damage from crushing or sagging. Damage to cables and cords can lead to electrical fires because bent and twisted cables can potentially fray and spark. Similarly, cables that are situated closely together and are not properly ventilated can produce heat or sparks and cause a fire.

Additionally, intertwined electrical cords creates an unpleasant disarray in the household or workplace, collecting dust beneath its tangles and making it difficult to untangle and visually differentiate between multiple cables. This is particularly true for many people who utilize extension cords or power strips to plug in multiple appliances and electronic devices at the same time. Messy, tangled cables and cords can also create liabilities such as tripping hazards.

The present invention is a cable management device designed to prevent electrical cords from entanglement. The present invention allows for the placement of individual electrical cords in a housing with a channel. Furthermore, the present invention secures electrical cords in place and retains them via a pivotally attached lid disposed over the channel of the housing member. The lid comprises a knob attached thereto. The knob is opposite and in direct alignment with an aperture disposed on the housing member. In this way, the knob is press fitted into the aperture, thereby securing the lid in a closed configuration. Use of the present invention provides a user with a more organized space, and can also extend the life and maximize the performance of the cables and cords.

The present invention may be used with a number of different types of cables and electrical cords. The primary advantage of the present invention is not only its compact design, but more specifically the separation method associated with the housing members. The housing members are removably connected to each other via a connecting member that is composed of rubber, plastic, or other suitable material. The connecting member is a thin panel that extends between the front wall and the back wall of the housing members, and is constructed so that it may be cut with a pair of scissors or other cutting device. In this way, the construction of the housing members allows the housing members to be separated from each other, which enables the user to choose the necessary number of housing members to use.

2. Description of the Prior Art

Devices have been disclosed in the prior art that relate to cable organizers. These include devices that have been patented and published in patent application publications, and generally relate to cable organizers having a housing with a plurality of grooves thereon. Some of these devices disclose a cable housing comprising a first and a second member that secures multiple electrical cords therein. Other devices disclose a strap system for binding multiple cables and electrical cords together. These devices, however, do not provide a plurality of housing members having a lid, wherein the housing members may be separated from each other. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,227,502 to Derman discloses a gripper device having a first member and a second member having a plurality of grooves for securing a power cord therein. The first member comprises a projection having a T-shaped cross section. The projection is sized to fit in a mating cavity disposed on the second member. In this way, the first member may be removably connected to the second member. The device may further comprise a wire cable to secure the power cords held therein. Although the device of Derman facilitates the organization of power cords by separating the individual power cords, the Derman device is limited in the fact that it fails to disclose a labeling system to identify each of the power cords held therein. Furthermore, the first and second members of the Derman device cannot be separated to form multiple housing members. Conversely, the present invention comprises a plurality of color coded housing members that may be separated from each other.

Another device, U.S. Pat. No. 8,342,459 to Garrison, discloses a wire organizer comprising a wire comb having wire receiving channels thereon. The channels may vary in size to accommodate wires of various shapes and sizes. Each wire receiving channel includes a notch to allow the wire receiving channels to flex slightly to facilitate insertion of a wire. In one embodiment, Garrison further discloses a cable cuff for restraining individual wires. While the Garrison discloses a device for separating individual wires, the Garrison device is limited in the fact that each of the wire receiving channels cannot be separated from the wire comb. The present invention provides a cable management device comprising a plurality of housing members that may be separated from one another. In this way, the present invention allows a user to utilize as many housing members as needed.

U.S. Pat. No. 2,650,948 to Findlay discloses a wire holder comprising a housing with a bottom wall, side walls, and an open top. The side walls comprise a plurality of recessed portions thereon for holding individual wires therein. The open top comprises a door hingedly attached thereto, securing the individual wires held in the recessed portions. The door is secured in a closed configuration via a latch attached thereto. In contrast, the present invention comprises a housing member with a lid having a knob attached thereto. The knob is opposite and in direct alignment with an aperture disposed on the housing. In this way, the knob is press fitted into the aperture, thereby securing the lid in a closed configuration.

U.S. Pat. No. 7,124,975 to Richardson (Richardson '975) and U.S. Pat. No. 7,469,854 to Richardson (Richardson '854) disclose a cord organizer comprising a base and a flexible strap attached thereto. The strap is adapted to retain a plurality of wires in a bundle to reduce clutter. The base may be adjusted in length so that the wires are pressed together and restrained from movement, thereby preventing the wires from entanglement. The purpose and design of the foregoing Richardson '975, '854 devices, however, differ from the present invention. These devices are designed to keep wires together in a bundle to reduce clutter. In contrast, the present invention is designed to organize various wires and cables so that each wire and cable is separate from one another and easily identifiable. As such, the present invention comprises a separate housing member for each cable or wire. In a preferred embodiment, the housing members are also color coded such that each cable is associated with a particular color.

U.S. Pat. No. 7,514,630 to Anderson discloses a removable harness for disentangling wires. The device includes a first member that is removably attached to a second member via an axle. The axle allows the first and second members to be easily rotated with respect to each other. The second member comprises a plurality of U-shaped grooves on its top side, which is in contact with the bottom side of the first member. The openings formed by the grooves are adapted to receive wires therethrough. While the first member secures the wires in the grooves, the Anderson device is limited in the fact that the first and second members can be easily rotated with respect to each other. Thus, the wires may be dislodged from the grooves of the second member.

Finally, U.S. Pat. No. 7,446,260 to Hammonds discloses a cable organizing comprising a box-like housing having a closed top wall, back wall, bottom wall, side walls, and an open front. Each of the side walls comprise a plurality of slots thereon for receiving cables. The open front comprises a cover that is removably attached thereto. The Hammonds device, however, is substantially unitary in structure such that each slot cannot be separated from one another. Additionally, the bulkiness of the housing prevents the user from placing the device behind or under furniture. In contrast, the present invention provides a plurality of compact housing members that may be separated from each other. In this way, the present invention increases flexibility and versatility to the user by allowing the user to use as many housing members as needed.

The devices disclosed in the prior art have several known drawbacks. These devices disclose a unitary housing member that cannot separate each of the wire receiving channels or grooves thereon. The present invention overcomes these limitations by disclosing a plurality of housing members that can be separated from each other. Furthermore, the prior art devices fail to disclose a pivotally attached lid that can be secured to the housing member via press fit. It is therefore submitted that the present invention is substantially divergent in design elements from the prior art, and consequently it is clear that there is a need in the art for an improvement to existing cable organizers. In this regard, the instant invention substantially fulfills these needs.

### SUMMARY OF THE INVENTION

In view of the foregoing disadvantages inherent in the known types of cable organizers now present in the prior art, the present invention provides a new and improved cable management device wherein the same can be utilized for organizing cables and electrical cords.

It is therefore an object of the invention to provide a new and improved cable management device that has all of the advantages of the prior art and none of the disadvantages.

Another object of the present invention is to provide a new and improved cable management device that is configured to keep electronic wires and cables in a neat and organized manner.

Yet another object of the present invention is to provide a new and improved cable management device having a housing member with a channel adapted to hold a single cable therein.

Still yet another object of the present invention is to provide a new and improved cable management device having a plurality of housing members removably connected to each other.

Still yet another object of the present invention is to provide a new and improved cable management device that is color coded.

Still yet another object of the present invention is to provide a new and improved cable management device that can accommodate electrical cords of various shapes and sizes.

Still yet another object of the present invention is to provide a new and improved cable management device having a pivotally attached lid that may be secured to the housing member via press fit.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the present invention.

FIG. 2 shows a perspective view of the housing members in a separated configuration.

FIG. 3 shows a view of the present invention in use.

### DETAILED DESCRIPTION OF THE INVENTION

References are made herein to the attached drawings. Like reference numerals are used throughout the drawings to depict like or similar elements of the cable management device. For the purposes of presenting a brief and clear description of the present invention, the preferred embodiment will be discussed as used to organize cables and electrical cords. The figures are intended for representative purposes only and should not be considered to be limiting in any respect.

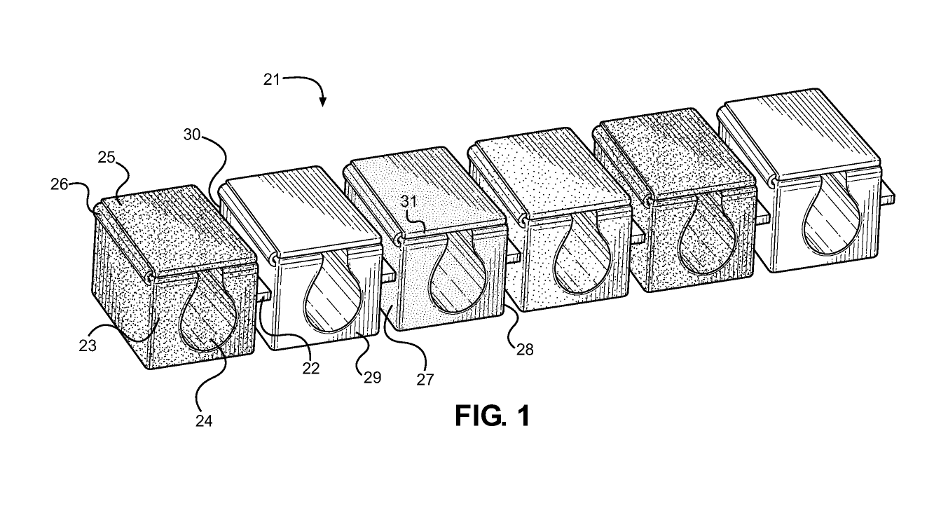

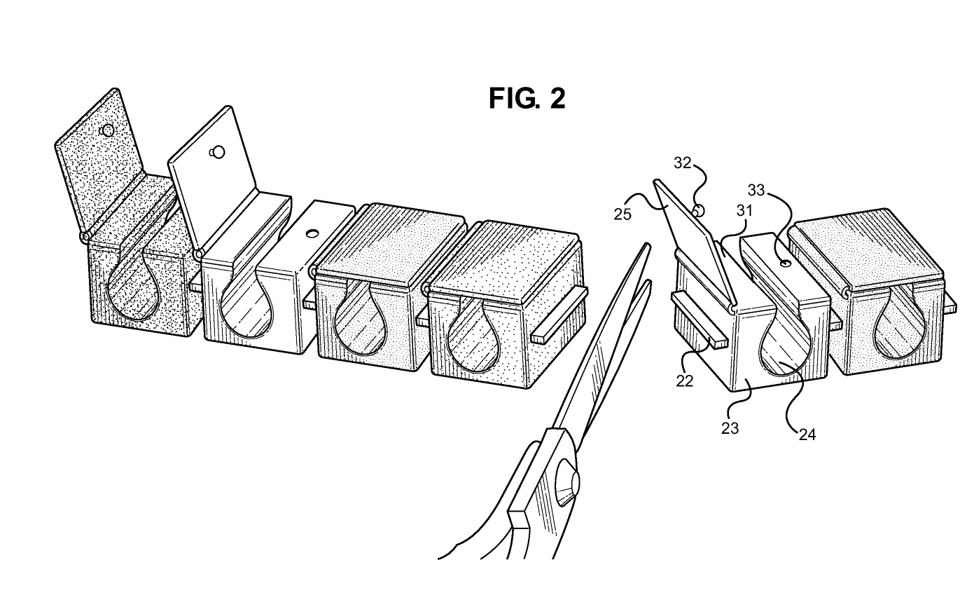

Referring now to FIGS. 1 and 2, there are shown perspective views of the cable management device 21 present invention. The present invention comprises a plurality of housing members 23 composed of soft plastic, hard rubber, or other suitable material. Each of the housing members 23 is generally box-like in shape and comprises a top wall 31, bottom wall, front wall 29, back wall 30, first side wall 27, and second side wall 28. Thus, the housing members 23 are substantially rectangular in shape.

The top wall 31 comprises a channel 24 that extends from the front wall 29 to the back wall 30. The channel 24 is generally tubular in shape, and is dimensioned to receive a cable or electrical cord therein. The channel 24 extends from the front wall 29 to the back wall 30 so that one end of the cable can emerge from the front wall 29 and the opposite end of the cable can emerge from the back wall 30. As such, the housing member 23 of the present invention holds a portion of the cable therein. In a preferred embodiment, the channel 24 tapers from the bottom wall to the top wall 31 so as to prevent cables from unintentionally or accidentally dislodging during use.

The top wall 31 of the housing 23 further comprises a rectangular lid 25 having a longitudinal side 26. The lid 25 is dimensioned so that, when placed on the top wall 31, the lid 25 covers the top wall 31 completely, thereby blocking the channel 24. The longitudinal side 26 of the lid 25 is pivotally attached to the top wall 31 so that it is configured to move between opened and closed positions. It is contemplated that the lid may be biased to the open position. The lid 25 and the housing 23 may be substantially unitary in structure, thereby eliminating the need for fastening means to connect the lid 25 to the housing 23.

The lower surface of the lid 25 comprises a knob 32 that can be inserted through an aperture 33 disposed on the top wall 31. The knob 32 is located opposite and in direct alignment with the aperture 33 disposed on the top wall 31. In this way, the knob 32 may be press fitted into the aperture 33, thereby securing the lid 25 in the closed position. When the lid 25 is secured in the closed position, the cable is secured within the channel 24.

Each of the adjacent housing members 23 is connected via a connecting member 22 disposed on the first side wall 27 and second side wall 28. The connecting member 22 is a breakable or a separable portion between the adjacent housing members 23, and comprises a thin panel of rubber, plastic, or other suitable material. If the housing member 23 is the endmost housing member, the endmost housing member may comprise the connecting member 22 on either the first side wall 27 or the second side wall 28. For example, the first housing member comprises the connecting member 22 only on the second side wall 28, as illustrated in FIG. 1.

The connecting members 22 keep the housing members 23 side-by-side, thereby keeping individual cables separate and organized. All of the housing members 23 may be used at the same time or individually as desired. As shown in FIG. 2, a user may separate the housing members 23 by cutting the connecting member 22 with scissors or other cutting means. In this way, the user can utilize as many housing members 23 desired.

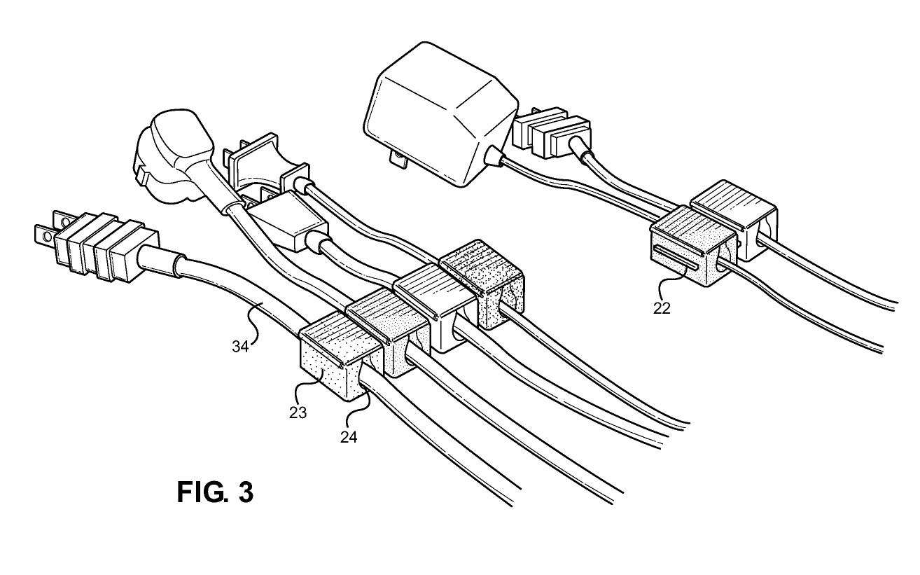

Referring now to FIG. 3, there is shown a view of the present invention in use. In operation, the lid may be disengaged from the top wall of the housing member 23 so that the channel 24 of the housing member 23 may receive a single cable 34 therein. The housing member 23 may be slightly flexed so as to allow the cable 34 to be inserted through the opening on the top wall and into the channel 24. Thereafter, the cable 34 may be secured in place when the lid is positioned over the top wall of the housing member 23. The housing member 23 may be snugly secured to the cable so that it is prevented from shifting or moving along the length of the cable during use. It is preferred that the housing member 23 is adapted to hold a single cable 34 therein so as to organize the individual cords and prevent the multiple cords from tangling.

The housing member 23 is configured to organize and neatly present cords for safe and convenient accessibility. In one embodiment, the housing members 23 may be color coded to allow the user to identify the electrical cord held therein. The user may assign a specific cable or wire for each of a plurality of colors. In some embodiments, the housing members 23 may further comprise a printed design or pattern thereon. Additionally, the housing members 23 may comprise differently sized recessed cavities 24 to accommodate cables of different shapes and sizes.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A cable management device, comprising:
a plurality of housing members having a top wall, bottom wall, front wall, back wall, and side walls;
a lid pivotally attached to said top wall;
said top wall having a channel that extends from said front wall to said back wall;
a plurality of connecting members connecting said plurality of housing members;
wherein said plurality of connecting members are attached to said side walls.

2. The cable management device of claim 1, wherein said channel is tapered toward said top wall.

3. The cable management device of claim 1, wherein said lid comprises a knob and said top wall further comprises an aperture adapted to receive said knob.

4. The cable management device of claim 1, wherein said plurality of connecting members comprises a thin panel of rubber that extends from said front wall to said back wall.

5. The cable management device of claim 1, wherein said plurality of housing members are arranged in a side-by-side orientation.

6. The cable management device of claim 1, wherein said plurality of housing members can be separated by cutting.
